(19) United States
(12) Patent Application Publication
(10) Pub. No.: US 2024/0353799 A1
(43) Pub. Date: Oct. 24, 2024

(54) CHRONOGRAPH MECHANISM COMPRISING A DEVICE FOR HOLDING IN POSITION A CHRONOGRAPH COUNTER DISPLAY FOR A HOROLOGICAL MOVEMENT, IN PARTICULAR IN A REFERENCE POSITION

(71) Applicant: Blancpain SA, Le Brassus (CH)

(72) Inventor: Lilian JOLY, Sirod (FR)

(73) Assignee: Blancpain SA, Le Brassus (CH)

(21) Appl. No.: 18/609,814

(22) Filed: Mar. 19, 2024

(30) Foreign Application Priority Data
Apr. 19, 2023 (EP) 23168658.5

(51) Int. Cl. G04F 7/08

(52) U.S. Cl. CPC G04F 7/0866; G04F 7/0804

(57) ABSTRACT

A chronograph mechanism (10) for a horological movement (1) having a chronograph train (20) including: a seconds counter (210), forming a first chronograph counter, having a seconds counter arbor (211) carrying a seconds counter display (214), a seconds counter wheel (212), and a drive finger (215) configured to drive an inter-counter wheel (23) in steps on each revolution of the seconds counter wheel; a second chronograph counter (220) having a second chronograph counter arbor (221) carrying a second chronograph counter display (224), and a second chronograph counter wheel (222) set in motion by said inter-counter wheel. A position-holding device (240) holds the second chronograph counter display in position, and is configured to ensure that the second chronograph counter display is held in position only when the second chronograph counter display is in an angular reference position and when the chronograph mechanism is stopped.

### CROSS REFERENCE TO RELATED APPLICATION

This application claims priority to European Patent Application No. 23168658.5 filed Apr. 19, 2023, the entire contents of which are incorporated herein by reference.

### TECHNICAL FIELD OF THE INVENTION

The present invention relates to a chronograph mechanism comprising a device for holding in position a display of a chronograph counter for a horological movement, in particular for holding in a reference position.

The invention further relates to a horological movement comprising such a chronograph mechanism.

The invention further relates to a timepiece comprising such a horological movement.

### TECHNOLOGICAL BACKGROUND

Chronograph mechanisms allow time to be measured on demand by means of a plurality of chronograph counters, for example minute and seconds counters.

Play in chronograph counter displays is a well-known problem in watchmaking. This play is more noticeable and more problematic after the counters have been reset to zero.

This play can cause the displays to wobble, which is visible to the user, particularly in the event of minor impacts. This play can also cause the display to move ahead of the dial graduation, particularly in relation to the reference position.

This play in the displays is due in particular to the various gears that accumulate in the gear train between the seconds counter engaged with the running train and the various counters of the chronograph set in motion from the seconds counter.

To avoid this undesirable play in chronograph displays, use of a jumper acting on a wheel of the minute counter wheel set is known, in order to maintain the stability of each of the angular positions assumed by the wheel of the minute counter wheel set. The action of such a jumper is permanent, thus maintaining the stability of the minute counter display in each of the positions both when the chronograph mechanism is stopped and when it is started up.

Conventionally, the jumper has a beak ending in two inclined planes configured to bear between the tips of two consecutive teeth of the wheel of the minute counter wheel set. When the wheel of the minute counter wheel set is driven by the seconds counter wheel set via a gear train, the teeth of the wheel of the minute counter wheel set lift the jumper, which then falls between two other teeth.

It is easy to understand that such a holding device for holding the minute counter in position generates relatively high power consumption with each step through which the minute counter is driven.

This power consumption can cause the rate of the horological movement to vary or the amplitude of the regulating member to vary. These variations in the rate of the movement or in the isochronism of the regulating member are due at least in part to the fact that the power consumed does not stay the same during the start-up of the chronograph mechanism, since it is consumed during each complete revolution of the seconds counter when the minute counter is driven.

As a result, there is a need to improve chronograph mechanisms and in particular the holding devices for holding chronograph counter displays in position.

### SUMMARY OF THE INVENTION

In this context, the invention proposes a chronograph mechanism for a horological movement that meets this need.

In this context, the invention relates to a chronograph mechanism for a horological movement having a chronograph train comprising a seconds counter, forming a first chronograph counter, comprising a seconds counter arbor carrying a seconds counter display, a seconds counter wheel, and a drive finger configured to drive an inter-counter wheel in steps during each revolution of the seconds counter wheel; a second chronograph counter comprising a second chronograph counter arbor carrying a second chronograph counter display, and a second chronograph counter wheel that is set in motion by said inter-counter wheel.

The chronograph mechanism further comprises a position-holding device for holding the second chronograph counter display in position, which position-holding device is configured to ensure that the second chronograph counter display is held in position only when the second chronograph counter display is in a predetermined angular reference position and when the chronograph mechanism is stopped.

Such a position-holding device according to the invention makes it possible to avoid the wobbling and angular play that can be visible to the user on the display of a chronograph counter after a reset when the chronograph train is no longer engaged with the running train and when the various wheel sets of the chronograph train are no longer engaged with one another.

In addition to the features mentioned in the preceding paragraph, the horological movement according to the invention can have one or more complementary features from among the following, considered either on an individual basis or according to any combination technically possible:
the position-holding device comprises:
   a positioning cam that rotates as one with the second chronograph counter arbor,
   a jumper configured to cooperate with the positioning cam and ensure that the positioning cam is held in said angular reference position of the second chronograph counter display when the chronograph mechanism is stopped;
said positioning cam is superimposed on said second chronograph counter wheel;
the positioning cam has a projecting relief configured to cooperate with a complementary relief of the recessed jumper configured to receive and house the projecting relief of the positioning cam;
the positioning cam has a recessed relief configured to cooperate with a complementary relief, which is a projecting relief, of the jumper configured to be housed in the recessed relief of the positioning cam;
the positioning cam further forms a reset cam for the second chronograph counter;
the positioning cam is heart-shaped, with the jumper cooperating with the tip of the heart to hold the second chronograph counter display in said angular reference position when the chronograph is stopped;
the jumper has a recessed relief configured to cooperate with the tip of the heart of the positioning cam forming a projecting relief;
the jumper has a projecting relief configured to cooperate with a recessed relief formed at the tip of the heart of the positioning cam;
the jumper is a one-piece part, comprising a portion whereof is capable of moving resiliently and cooperates with the positioning cam;
the jumper comprises a lever capable of rotating about an axis of rotation and which cooperates with a resilient member working to position the lever so that it bears against the positioning cam;
the position of the axis of rotation of the lever can be adjusted by an eccentric to fine-tune the angular reference position of the second chronograph counter display;
the chronograph mechanism comprises a gear train arranged between the seconds counter and the second chronograph counter, said gear train comprising said inter-counter wheel;
said angular reference position of the second chronograph counter display is a reference position or reset position;
the second chronograph counter is a chronograph hour counter or a chronograph minute counter.

Another aspect of the invention relates to a horological movement comprising a chronograph mechanism according to the invention.

The invention further relates to a timepiece comprising a horological movement according to the invention.

The timepiece is, for example, a wristwatch comprising a watch case configured to receive and house the horological movement according to the invention.

### BRIEF DESCRIPTION OF THE FIGURES

The purposes, advantages and features of the present invention will be better understood upon reading the detailed description given below with reference to the following figures:

FIG. 1 is a diagrammatic, perspective view of a first example embodiment of a chronograph mechanism according to the invention comprising a position-holding device for holding a chronograph counter in position, in particular in a reference position;

FIG. 2 shows a top view of the chronograph mechanism in FIG. 1;

FIG. 3 shows a bottom view of the chronograph mechanism in FIG. 1;

FIG. 4 is a functional block diagram of the chronograph mechanism of a horological movement according to the invention, shown in FIG. 1, illustrating the interactions between the various elements of the horological movement and of the chronograph mechanism;

FIG. 5 is a diagrammatic, perspective view of a second example embodiment of a chronograph mechanism according to the invention comprising a position-holding device for holding a chronograph counter in position, in particular in a reference position.

In all the figures, common elements bear the same reference numerals unless specified to the contrary.

### DETAILED DESCRIPTION OF THE INVENTION

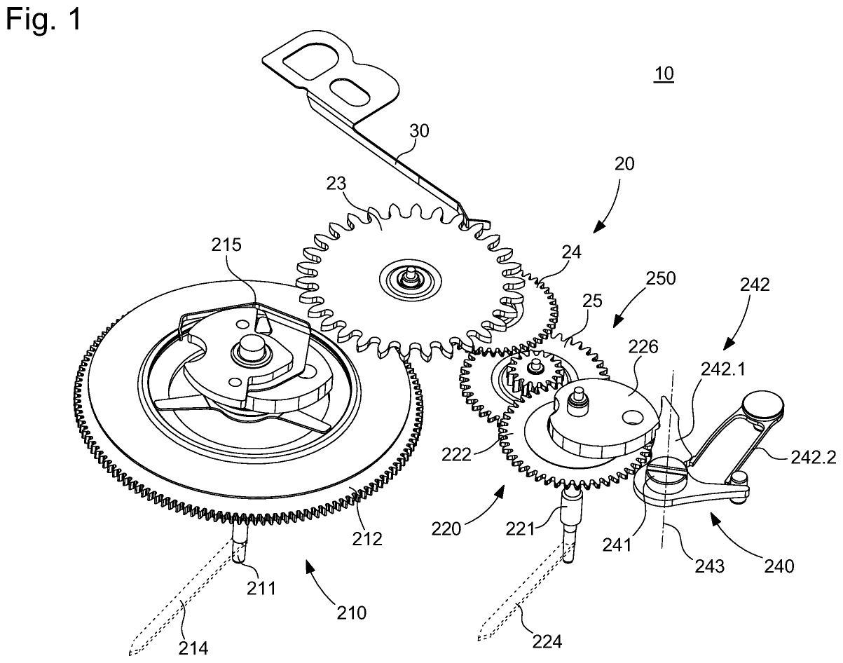

FIG. 1 is a diagrammatic, perspective view of a first example embodiment of a chronograph mechanism 10 according to the invention comprising a position-holding device 240 for holding a chronograph counter in position, in particular in a reference position.

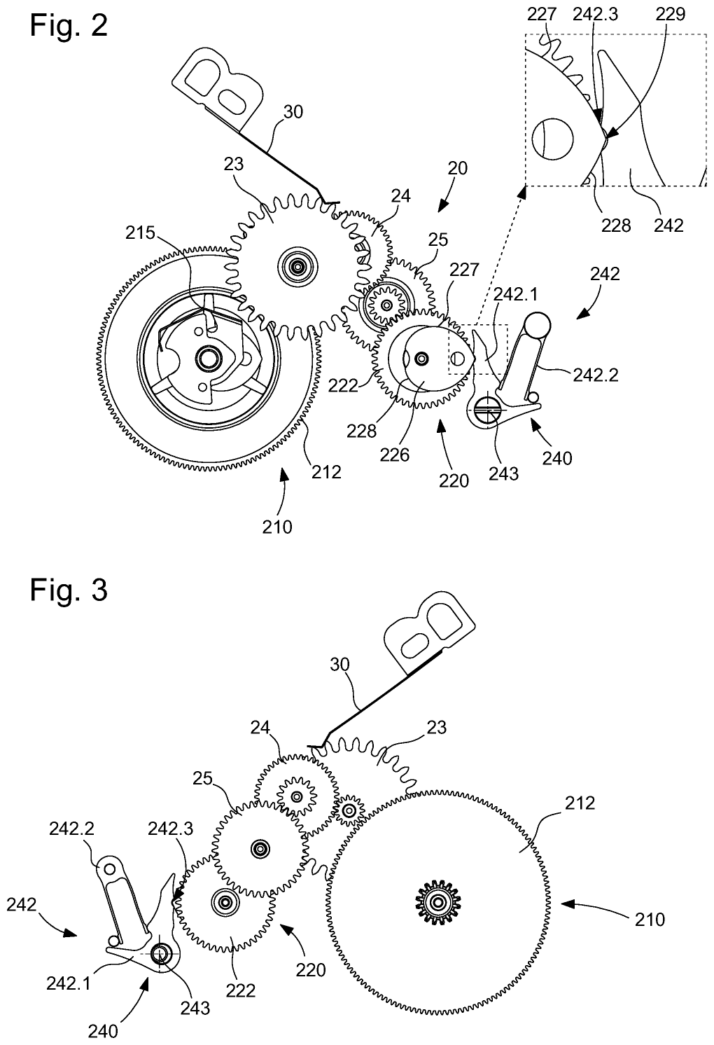

FIG. 2 shows a top view of the chronograph mechanism 10 in FIG. 1.

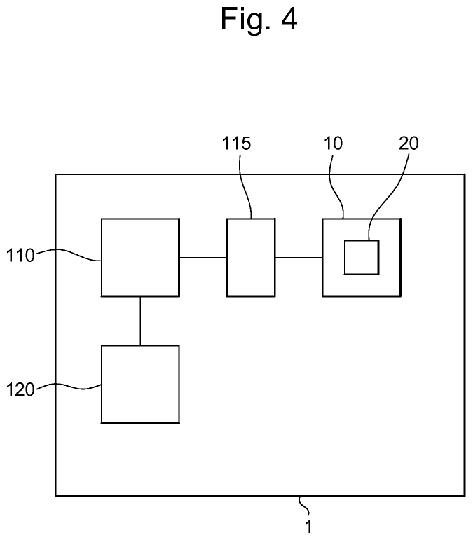

FIG. 3 shows a bottom view of the chronograph mechanism 10 in FIG. 1.

FIG. 4 is a functional block diagram of the chronograph mechanism 10 of a horological movement 1, according to the invention, illustrating the interactions between the various elements of the horological movement 1 and of the chronograph mechanism 10 that will be described hereinbelow.

Conventionally, the chronograph mechanism 10 is configured to be coupled to and driven, on demand, by a running train 110, dedicated to the graduation of time, of a horological movement 1, via a coupling device 115. Conventionally, the running train 110 is regulated by a regulating member 120.

Conventionally, the running train 110 drives the hands of a time display, in particular an hour hand cooperating with an hour graduation, a minute hand cooperating with a minute graduation, and a seconds hand, or trotteuse hand, cooperating with a seconds graduation.

The chronograph mechanism 10 comprises a chronograph train 20 comprising a first chronograph counter 210 configured to be driven by the running train and regulated in time with the regulating member 120 of the horological movement 1, via the coupling device 115. Conventionally, this first chronograph counter 210 is a chronograph seconds counter.

The chronograph seconds counter 210 comprises a seconds wheel 212, also referred to as a chronograph wheel, mounted on a seconds arbor 211 which carries and is rigidly connected to a chronograph seconds display 214, for example a chronograph seconds hand.

The chronograph seconds counter 210 comprises a drive finger 215 rotating as one with the seconds arbor 211 and configured to drive an inter-counter wheel 23 in steps on each complete revolution of the chronograph seconds counter 210.

In the example embodiment shown, the drive finger 215 is a flexible drive finger, but other configurations are possible while still remaining within the scope of the invention.

The chronograph train 20 comprises at least one second chronograph counter 220 comprising a second chronograph counter wheel 222 mounted on a second chronograph counter arbor 221 carrying and rigidly connected to a second chronograph counter display 224, for example a hand.

The second chronograph counter 220 can be a chronograph minute counter or a chronograph hour counter.

The position-holding device 240 for holding the chronograph mechanism 10 in position according to the invention makes it possible to hold the chronograph counter with which it is associated in position, in this example embodiment, the second chronograph counter 220, when the chronograph mechanism 10 is stopped, and only in a predetermined angular position of the counter display, preferably in the reference position of the display, for example in a reset position of the display.

Preferably, the second chronograph counter 220 is an hour counter and the chronograph mechanism 10 according to the invention comprises a position-holding device 240 holding the hour counter in position, in particular in the reference position.

More specifically, the position-holding device 240 according to the invention is particularly useful when associated with an hour counter, as the wobbling of the hour display is more visible to the user after a reset, notably because of the various gear clearances that exist in a gear train 250 provided between the chronograph seconds counter 210 and the chronograph hour counter, in this case the second chronograph counter 220.

The gear train 250 comprises the inter-counter wheel 23, which is driven in steps with each complete rotation of the seconds counter 210.

In the example embodiment illustrated, the gear train 250 further comprises two intermediate wheels 24, 25 positioned between the inter-counter wheel 23 and the second chronograph counter 220, in particular to obtain the desired gear ratio at the second chronograph counter wheel 222.

For example, if the second chronograph counter 220 is an hour counter making one complete revolution in 12 hours, the gear train 250 is shaped to obtain a reduction ratio of 1/24 with an inter-counter wheel 23 comprising 30 teeth and driven by one step per minute.

The inter-counter wheel 23 cooperates with a jumper 30 having a beak terminating in two inclined planes configured to cooperate with the tips of two consecutive teeth of the inter-counter wheel 23 in order to hold the angular position of said inter-counter wheel 23 upon each step.

Preferably, the jumper 30 comprises adjustment means for adjusting the relative position of the jumper 30 to the inter-counter wheel 23, so as to be able to modify the angular position of the inter-counter wheel 23, in order to position it correctly relative to the drive finger 215 of the seconds counter 210.

Advantageously, the position-holding device 240 is a reference-position-holding device configured to ensure that the second chronograph counter display 224 is held stably in the reference position, in particular following a reset of the chronograph counters, when the second chronograph counter wheel 222 and the various wheel sets of the gear train 250 are no longer in driving contact with the running train 210.

Thus, the position-holding device 240 ensures that the second chronograph counter display 224 is held stably in the reference position, when the latter is in the reference position and when the chronograph train 20 is not driven by the running train 110 of the horological movement 1.

The position-holding device 240 comprises:
a positioning cam 226 that rotates as one with the arbor of the second chronograph counter 221,
a jumper 242 configured to cooperate with the positioning cam 226.

The positioning cam 226 is a different part from the second chronograph counter wheel 222.

The positioning cam 226 is superimposed on the second chronograph counter wheel 222, so that the jumper 242 interacts only with the positioning cam 226 and not with the second chronograph counter wheel 222.

As a result, it is perfectly clear that the position-holding device 240 according to the invention is different from an indexing device configured to index each step or angular position of the second chronograph counter by interacting with the teeth of the second chronograph counter wheel 222.

The positioning cam 226 has a relief 229 configured to cooperate with a complementary relief 242.2 of the jumper 242. Thus, the positioning cam 226 has only one possible indexing position.

In the first example embodiment illustrated in FIGS. 1 to 3, the positioning cam 226 further forms a reset cam for resetting the second chronograph counter 220. Such an embodiment allows two functions to be combined within the same part, using two different regions of the heart shape. This minimises the overall dimensions of the chronograph mechanism 10.

For example, the positioning cam 226 is heart-shaped. In this example embodiment, the tip of the heart joining the two lobes 227, 228 forms the relief 229 of the positioning cam 226.

Thus, the tip of the heart forms a projecting relief 229 configured to cooperate with the jumper 242 and more particularly with a complementary relief 242.3 in the form of a recess in the jumper 242 configured to receive and house the tip of the heart of the positioning cam 226, so as to hold it in this particular angular position when no driving force is applied to the chronograph train 20 or the second chronograph counter 220.

In one alternative embodiment, a recess can be formed at the end of the tip of the heart shape so as to cooperate with a complementary projecting relief formed at the jumper 242.

The jumper 242 can be a one-piece part, a portion whereof is capable of moving resiliently and is configured to cooperate with the positioning cam 226.

According to the example embodiment illustrated in FIGS. 1 to 3, the jumper 242 comprises a lever 242.1 capable of rotating about an axis of rotation 243 and which cooperates with a resilient member 242.2 working to position the lever 242.1 so that it bears against the positioning cam 226.

The resilient member 242.2 is shaped so that the lever 242.1 generates a low frictional force on the smooth part of the positioning cam 226, and a higher frictional force when the reliefs of the positioning cam 226 and of the jumper 242 cooperate to hold the second chronograph counter display 224 in the reference position. Thus, to disengage the relief 229 of the positioning cam 226 from the relief 242.3 of the jumper 242, a certain torque must be applied to the second chronograph counter 220. For example, starting the chronograph mechanism 10 driving the chronograph train 10 generates a torque at the second chronograph counter 220, which torque is sufficient to disengage the respective reliefs 229, 242.3 of the positioning cam 226 and of the jumper 242.

Generally speaking, the jumper 242 is configured to generate a positioning torque for the positioning cam 226 that is sufficient to overcome the unbalance that can exist at the second chronograph counter display 224, for example during small impacts to the horological movement 10.

Without any particular action on the chronograph train 20 (reset or start-up), the engagement of the relief 229 of the positioning cam 226 with the complementary relief 242.3 of the jumper 242 prevents the second chronograph counter display 224 from wobbling and ensures that it is held in position, preferably in the reference position, as long as the chronograph mechanism 10 is not started.

Thus, the position-holding device 240 according to the invention offers a solution that allows for reduced power consumption, with a peak in power consumption only on the passage of the relief 229 of the positioning cam 226 when the second chronograph counter 220 completes a full revolution, the friction force generated between the smooth part of the positioning cam 226 and the jumper 242 being negligible outside of the passage of the relief 229.

The position of the axis of rotation 243 of the lever 242, and more precisely of the lever 242.1, can be adjusted by means of an eccentric 241. The eccentric 241 allows the position of the lever 242.1 and the position of the complementary relief 242.3 to be precisely adjusted so as to ultimately modify the angular holding position of the second chronograph counter display 224 relative to the graduation of a dial. Thus, the eccentric 241 makes it possible to adapt to the different manufacturing tolerances of the various components of the horological movement 1 and to fine-tune the angular holding position of the second chronograph counter display 224.

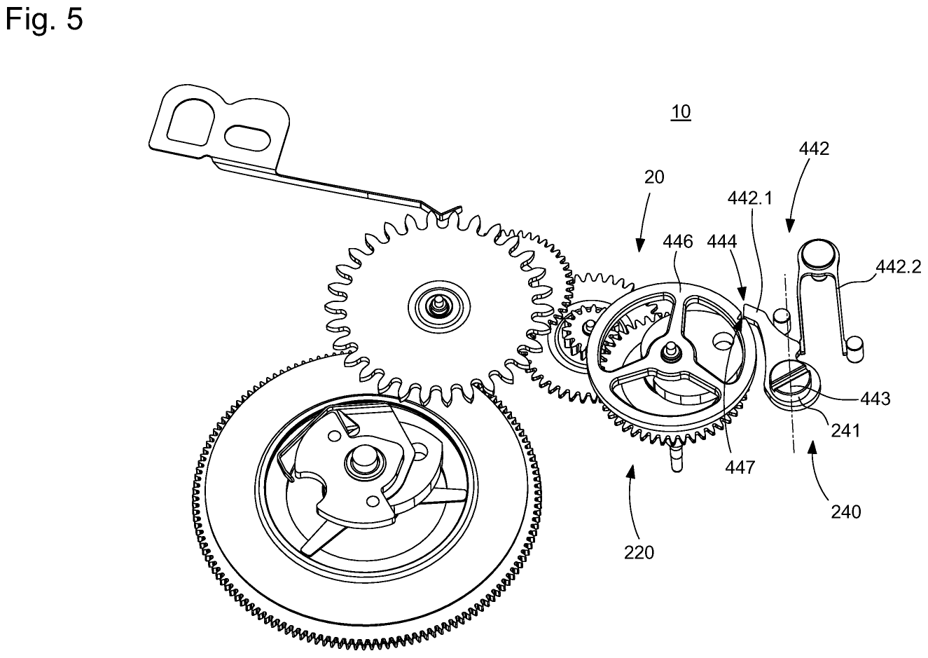

FIG. 5 shows a second example embodiment of a chronograph mechanism 10 according to the invention. This second example embodiment is identical to the first example embodiment described above, with the exception of the features which will be described.

In this second example embodiment, the positioning cam 446 is dissociated from the reset cam of the second chronograph counter 220.

The positioning cam 446 has the shape of a smooth wheel with a circular cam track which has a recessed relief 447 configured to cooperate with a projecting relief 444 of the jumper 442. It goes without saying that a reverse configuration is also possible.

In the same way as for the first example embodiment, the jumper 442 can be formed by a lever 442.1 capable of rotating about an axis of rotation 443 and which cooperates with a resilient member 442.2 working to position the lever 442.1 so that it bears against the positioning cam 426.

The invention further relates to a timepiece, for example a wristwatch, comprising such a horological movement.

1. A chronograph mechanism for a horological movement having a chronograph train comprising:
a seconds counter, forming a first chronograph counter, comprising a seconds counter arbor carrying a seconds counter display, a seconds counter wheel, and a drive finger configured to drive an inter-counter wheel in steps on each revolution of the seconds counter wheel; and
a second chronograph counter having a second chronograph counter arbor carrying a second chronograph counter display, and a second chronograph counter wheel set in motion by said inter-counter wheel;
wherein the chronograph mechanism comprises a position-holding device for holding the second chronograph counter display in position, which position-holding device is configured to ensure that the second chronograph counter display is held in position only when the second chronograph counter display is in an angular reference position and when the chronograph mechanism is stopped.

2. The chronograph mechanism according to claim 1, wherein the position-holding device comprises:
a positioning cam that rotates as one with the arbor of the second chronograph counter,
a jumper configured to cooperate with said positioning cam to ensure that the positioning cam is held in position when the second chronograph counter is in said angular reference position and when the chronograph mechanism is stopped.

3. The chronograph mechanism according to claim 2, wherein said positioning cam is superimposed on said second chronograph counter wheel.

4. The chronograph mechanism according to claim 2, wherein the positioning cam has a projecting relief configured to cooperate with a complementary relief of the recessed jumper configured to receive and house the projecting relief of the positioning cam.

5. The chronograph mechanism according to claim 2, wherein the positioning cam has a recessed relief configured to cooperate with a complementary relief, which is a projecting relief, of the jumper configured to be housed in the recessed relief of the positioning cam.

6. The chronograph mechanism according to claim 2, wherein the positioning cam further forms a reset cam for the second chronograph counter.

7. The chronograph mechanism according to claim 6, wherein the positioning cam is heart-shaped, and wherein the jumper cooperates with a tip of the heart to hold the second chronograph counter display in said angular reference position when the chronograph is stopped.

8. The chronograph mechanism according to claim 7, wherein the jumper has a recessed relief configured to cooperate with the tip of the heart of the positioning cam forming a projecting relief.

9. The chronograph mechanism according to claim 7, wherein the jumper has a projecting relief configured to cooperate with a recessed relief formed at the tip of the heart of the positioning cam.

10. The chronograph mechanism according to claim 2, wherein the jumper is a one-piece part, a portion whereof is capable of moving resiliently and cooperates with the positioning cam.

11. The chronograph mechanism according to claim 2, wherein the jumper comprises a lever capable of rotating about an axis of rotation and which cooperates with a resilient member working to position the lever so that it bears against the positioning cam.

12. The chronograph mechanism according to claim 11, wherein the position of the axis of rotation of the lever can be adjusted by an eccentric to fine-tune the angular reference position of the second chronograph counter display.

13. The chronograph mechanism according to claim 1, wherein it comprises a gear train arranged between the seconds counter and the second chronograph counter, said gear train comprising said inter-counter wheel.

14. The chronograph mechanism according to claim 1, wherein said angular reference position of the second chronograph counter display is a reset position.

15. The chronograph mechanism according to claim 1, wherein the second chronograph counter is a chronograph hour counter.

16. A horological movement comprising a chronograph mechanism according to claim 1.

17. A timepiece comprising a horological movement according to claim 16.
